(19) United States
(12) Patent Application Publication
(10) Pub. No.: US 2026/0237276 A1
(43) Pub. Date: Aug. 13, 2026

(54) SELF-CONTAINED PORTABLE SECURITY MONITORING SYSTEM

(71) Applicant: Transit Security Solutions, LLC, Atlanta, GA (US)

(72) Inventors: William B. Thorpe, Smyrna, GA (US); Kevin Kumar Prasad, Lawrenceville, GA (US)

(21) Appl. No.: 19/033,341

(22) Filed: Jan. 21, 2025

(51) Int. Cl. G08B 13/196; G06V 10/70; G06V 20/52; G06V 20/59; G08B 7/06

(52) U.S. Cl. CPC G08B 13/19647; G06V 10/70; G06V 20/52; G06V 20/59; G08B 7/06; G08B 13/1961; G08B 13/19621; G08B 13/19632; G08B 13/1966; G08B 13/19669; G08B 13/19673

(57) ABSTRACT

A portable monitoring system and device for securing cargo trailers is provided herein. The system includes a housing configured to be mounted within the interior of a cargo trailer. The housing comprises a monitoring unit containing a motion detection sensor, camera, and wireless communication module powered by a battery. A controller causes the monitoring unit to operate in a standby mode and transition to an active mode upon motion detection. When in active mode, the controller captures video and images, analyzes the captured visual data using artificial intelligence to determine if unauthorized activity has occurred, and transmits trigger event details including the video and images and location data to a remote monitoring system. The system operates independently of trailer power and vehicle operator interaction. The system effectively detects and deters unauthorized access while conserving battery power through intelligent operation modes.

### FIELD OF THE DISCLOSURE

Embodiments of the present disclosure relate generally to security monitoring systems and, more particularly, to portable security monitoring systems and devices for monitoring cargo trailers and detecting unauthorized activity during transit.

### BACKGROUND OF THE DISCLOSURE

Cargo theft in transit has become a concern, causing financial losses across the transportation industry. Traditional security measures often rely on fixed monitoring systems that require permanent installation or driver interaction. These systems can be costly to implement and maintain.

Many existing security systems require integration with vehicle power systems or cellular connectivity through a driver's device. This dependency creates vulnerabilities, particularly in scenarios where driver involvement may be a concern. Industry statistics indicate that a significant percentage of cargo theft involves internal personnel, making driver-independent security systems increasingly important. Current monitoring solutions also tend to be complex, requiring wiring or modifications to trailers. Additionally, battery-powered systems often struggle to maintain extended operational periods while providing comprehensive monitoring capabilities.

Furthermore, many existing systems lack detection capabilities, often relying on simple door sensors or motion detectors that can generate false alarms. The inability to verify and assess potential security breaches in real-time can lead to delayed responses or unnecessary interventions.

Consequently, there is a need for an improved security monitoring system that operates independently of vehicle systems and driver interaction, while providing reliable detection and notification of unauthorized activities during transit. Such a system may also enable communication with authorized personnel such as dock workers and delivery personnel during loading, unloading, and delivery operations, providing an additional layer of security verification while maintaining operational efficiency.

### BRIEF SUMMARY OF THE DISCLOSURE

Embodiments of the present disclosure provide various systems and devices that address the above-noted difficulties and challenges associated with monitoring cargo trailers during transit. In this regard, various embodiments provide portable security monitoring systems that can operate independently of vehicle power and driver interaction to detect and report unauthorized activities.

The portable monitoring systems described herein combine battery-powered operation with intelligent motion detection and imaging capabilities to provide comprehensive security monitoring. These systems can be temporarily mounted within cargo trailers and automatically transition between low-power standby and active monitoring modes to conserve battery life while maintaining security coverage. The monitoring systems enable remote verification of security events through automated image capture and analysis, helping to minimize false alarms while providing visual evidence of any unauthorized access. The systems can operate without requiring permanent modifications to trailers or integration with vehicle systems, allowing for flexible deployment across different trailers and locations.

The systems and devices disclosed herein include a portable security monitoring system that monitors activity within cargo trailers. The monitoring system may comprise a housing configured to be mounted within the interior of a cargo trailer, with the housing containing a monitoring unit that includes motion detection sensors, cameras, and wireless communication capabilities. The monitoring unit operates on battery power and communicates with remote monitoring systems to enable real-time detection and response to authorized and unauthorized activity and events. The monitoring system is configured to operate in different power modes to extend battery life while maintaining security coverage. The system operates primarily in a low-power standby mode and transitions to an active mode when motion is detected within the trailer. Upon activation, the system captures images or video of the cargo area and transmits this data, along with location information, to remote monitoring personnel who can assess the situation and respond appropriately. When in active mode, the system analyzes captured video and images using artificial intelligence to determine if unauthorized activity has occurred. If a security event is detected, the system transmits relevant details including the captured images/video, time stamps, and location data to the remote monitoring system. The system can also activate local alarm devices to deter intruders while maintaining a record of all detected events. The system is to be completely self-contained and portable, requiring no connection to vehicle power or communication systems. This independence from vehicle systems and driver interaction provides an additional layer of security, particularly in scenarios where internal theft may be a concern. The monitoring unit can be easily mounted within different trailers using existing track structures, enabling flexible deployment across various vehicles and locations.

In an example embodiment, a portable security monitoring system is provided for a cargo trailer. The portable security monitoring system comprises a housing configured to be mounted within an interior of the cargo trailer; a monitoring unit configured to be housed by the housing and comprising a motion detection sensor, a camera, an alarm device, a battery, a GPS device, and a wireless communication module configured to transmit video data and location data. The portable security monitoring system also comprises a controller operatively coupled to the monitoring unit. The controller is configured to cause the monitoring unit to operate in a low-power standby mode and cause the monitoring unit to transition to an active mode upon motion detection sensed by the motion detection sensor. When the monitoring unit transitions into active mode, it is configured to cause the camera to initiate video recording to capture video of the interior of the cargo trailer, use artificial intelligence to analyze the captured video to determine if a trigger event has occurred. If a trigger event has occurred, the controller causes the GPS device to capture location data for the monitoring unit and transmit the trigger event occurrence details to a remote monitoring system via the wireless communication module, and activate the alarm device in response to the detection of unauthorized activity, wherein the trigger event occurrence details comprises the captured video, a time stamp of the trigger event, and the location data.

In some embodiments, the system operates independently of a power source.

In some embodiments, the system does not require interaction from a vehicle operator.

In some embodiments, the monitoring unit comprises a machine learning module configured to analyze the captured video, detect pattern changes indicating unauthorized activity, and automatically generate an alert which corresponds to the type of unauthorized activity detected. The types of unauthorized activity may comprise door opening of the cargo trailer, human presence within the cargo trailer, and cargo removal or displacement.

In some embodiments, the system also comprises a two-way communication interface. The two-way communication interface comprises a microphone for receiving audio from within the cargo trailer, and a speaker for outputting audio from the remote monitoring system.

In some embodiments, the alarm device comprises a visual indicator capable of displaying varying illumination patterns, and a speaker configured to emit an audible alert.

In some embodiments, the camera is further configured to capture images of the cargo trailer interior in the active mode. Furthermore, the monitoring unit is configured to transmit the captured image to the remote monitoring system along with the captured video.

In some embodiments, the battery comprises a rechargeable battery configured to power the monitoring unit for a predetermined period in the standby mode.

In some embodiments, the portable security monitoring system also comprises a mounting feature for securing the housing to an interior track structure of the cargo trailer. The mounting feature comprises a bracket configured to engage with existing track structures within the cargo trailer.

In some embodiments, the system maintains a continuous video buffer that enables capture of video footage from before a trigger event occurs. The buffer has a predetermined duration of video capture prior to motion detection.

In some embodiments, the video recording is maintained for a predetermined duration following the motion detection of unauthorized activity.

In some embodiments, the motion detection sensor comprises at least one of: a passive infrared sensor, an optical sensor, a microwave sensor, or an ultrasonic sensor.

In some embodiments, the camera comprises an infrared camera configured to capture video in low-light conditions.

In another example embodiment, a portable security monitoring device for a cargo trailer is provided. The portable security monitoring system comprises a housing configured to be mounted within an interior of the cargo trailer; a monitoring unit configured to be housed by the housing and comprising a motion detection sensor, a camera, an alarm device, a battery, a GPS device, and a wireless communication module configured to transmit image data and location data. The portable security monitoring system also comprises a controller operatively coupled to the monitoring unit. The controller is configured to cause the monitoring unit to operate in a low-power standby mode, cause the monitoring unit to transition to an active mode upon motion detection sensed by the motion detection sensor. When the monitoring unit transitions into active mode, it is configured to: cause the camera to capture at least one image of the interior of the cargo trailer, use artificial intelligence to analyze the at least one image to determine if a trigger event has occurred. If a trigger event has occurred, the controller causes the GPS device to capture location data for the monitoring unit and transmit the trigger event occurrence details to a remote monitoring system via the wireless communication module and activate the alarm device in response to the detection of unauthorized activity. The trigger event occurrence details comprises the at least one captured image, a time stamp of the trigger event, and the location data.

In some embodiments, the monitoring unit comprises a machine learning module configured to: compare successive captured images, detect pattern changes indicating unauthorized cargo activity, and automatically generate an alert which corresponds to the type of unauthorized activity detected. The types of unauthorized activity may comprise door opening of the cargo trailer, human presence within the cargo trailer, and cargo removal or displacement.

In some embodiments, the system also comprises a two-way communication interface. The two-way communication interface comprises a microphone for receiving audio from within the cargo trailer, and a speaker for outputting audio from the remote monitoring system.

In some embodiments, the camera is further configured to capture video of the cargo trailer interior in the active mode, wherein the controller is configured to transmit the captured video to the remote monitoring system.

In some embodiments, the system maintains a continuous video buffer that enables capture of footage from before a trigger event occurs, wherein the buffer has a predetermined duration of video capture prior to motion detection.

In some embodiments, the system does not require interaction from a vehicle operator.

In another example embodiment, a remote monitoring device is provided for a cargo trailer. The remote monitoring device comprises a housing configured to be mounted within an interior of the cargo trailer; a monitoring unit configured to be housed by the housing. The monitoring unit comprises: a motion detection sensor, a camera, an alarm device, a battery, a GPS device, a machine learning module, and a wireless communication module configured to transmit image data, video data and location data. The remote monitoring device also comprises a controller operatively coupled to the monitoring unit and configured to: cause the monitoring unit to operate in a low-power standby mode, cause the monitoring unit to transition to an active mode upon motion detection sensed by the motion detection sensor. When the monitoring unit transitions into active mode, it is configured to, initiate video recording and capture at least one image via the camera of the detected motion, and analyze, using the machine learning module, the captured video and images to determine if a trigger event has occurred. If a trigger event has occurred, the controller causes the GPS device to capture location data for the monitoring unit and transmit the trigger event occurrence details to a remote monitoring system via the wireless communication module and activate the alarm device in response to the detection of unauthorized activity. The trigger event occurrence details comprises the captured video, the at least one captured image, a time stamp of the trigger event, and the location data.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 illustrates a schematic view of a security monitoring system including a portable monitoring unit deployed within a cargo trailer in a transportation environment, in accordance with some embodiments of the present disclosure;

FIG. 2A illustrates a perspective front view of the portable monitoring unit of FIG. 1 including ventilation slots, a GPS device, and speaker components, in accordance with some embodiments discussed herein;

FIG. 2B illustrates a perspective bottom view of the portable monitoring unit of FIG. 1 including motion sensors, camera, and microphone components, in accordance with some embodiments discussed herein;

FIG. 2C illustrates a front view of the portable monitoring unit of FIG. 2A, in accordance with some embodiments discussed herein;

FIG. 2D illustrates a rear view of the portable monitoring unit of FIG. 2A including a battery access port, in accordance with some embodiments discussed herein;

FIG. 2E illustrates a side view of the portable monitoring unit of FIG. 2A including mounting tabs, in accordance with some embodiments discussed herein;

FIG. 2F illustrates a top view of the portable monitoring unit of FIG. 2A, in accordance with some embodiments discussed herein;

FIG. 2G illustrates an isolated view of the mounting components of the portable monitoring unit of FIG. 2A, in accordance with some embodiments discussed herein;

FIG. 2H illustrates a bottom view of the portable monitoring unit of FIG. 2A, in accordance with some embodiments discussed herein;

FIG. 2I illustrates an internal component layout of the portable monitoring unit of FIG. 2A, in accordance with some embodiments discussed herein;

FIG. 3 illustrates the portable monitoring unit of FIG. 2A and its associated mounting bracket, in accordance with some embodiments discussed herein;

FIG. 4 depicts a flowchart illustrating the operational sequence of the portable monitoring unit upon detection of unauthorized activity, in accordance with some embodiments discussed herein; and

FIG. 5 illustrates a schematic overview of the communication architecture between the portable monitoring unit of FIG. 1 and remote monitoring system.

### DETAILED DESCRIPTION

Exemplary embodiments of the present disclosure will be described more fully hereinafter with reference to the accompanying drawings, in which some, but not all embodiments of the present disclosure are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

The present disclosure relates to security monitoring of cargo during transportation.

In particular, embodiments described herein provide systems and devices for detecting, analyzing, and responding to unauthorized access or tampering of cargo trailers during transit, storage, or delivery operations.

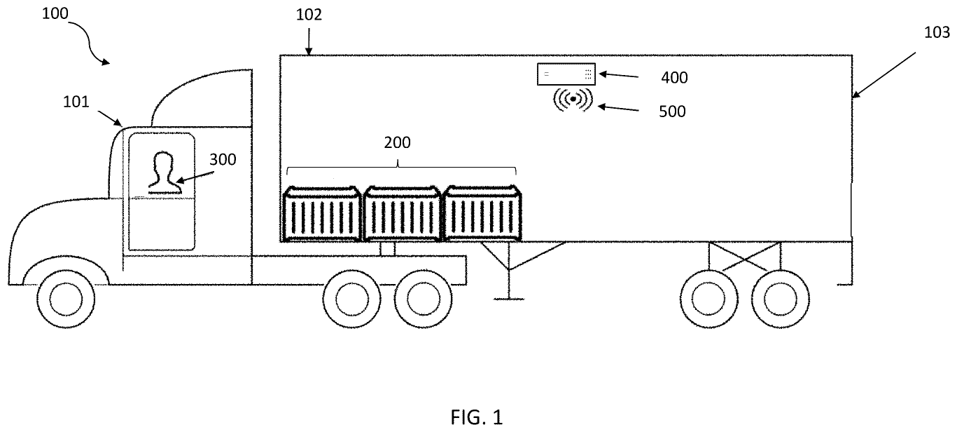

FIG. 1 illustrates a transportation system 100 including a tractor-trailer configuration commonly used in commercial freight operations. The transportation system 100 comprises a tractor unit 101 configured to pull a cargo trailer 102. The cargo trailer 102 includes a rear access door 103 through which cargo 200 can be loaded and unloaded. In the illustrated embodiment, the tractor unit 101 includes a cabin area where a vehicle operator 300 controls the transportation system 100. The cargo trailer 102 may be any suitable trailer type used in commercial transportation, including but not limited to semi-tractor-trailers, vans, refrigerated trailers, shipping containers, flatbeds with walls or curtains, containers, or other enclosed cargo carrying structures.

Traditional security approaches often rely on fixed trailer-mounted systems, satellite tracking, or driver-managed security protocols. However, these conventional methods typically require permanent installation, constant power supply, or active driver participation, creating potential vulnerabilities. Additionally, traditional systems that require driver interaction or vehicle power integration can be compromised, particularly in scenarios involving internal theft or tampering.

To address these challenges, the cargo trailer 102 may be equipped with a portable monitoring unit 400 mounted within its interior space. The portable monitoring unit 400 may be positioned near the rear door 103 of the cargo trailer 102 to provide monitoring of cargo access points. The portable monitoring unit 400 is configured to operate independently of any vehicle power systems, control systems, or other vehicle infrastructure. This independence enables the portable monitoring unit 400 to provide security monitoring without relying on or interfacing with the tractor unit 101 or requiring any interaction from the vehicle operator 300.

The portable monitoring unit 400 is configured to mount to existing track structures or “e-track” structures commonly found within cargo trailers. These track structures may comprise uniformly spaced slots typically running along the interior walls of the trailer used throughout the transportation industry for cargo securement. The monitoring unit 400 includes mounting features that engage with these track structures, enabling quick installation and removal without requiring any permanent modification to the trailer. This mounting system also helps prevent tampering, as the unit's attachment points become inaccessible once it is properly mounted to the track.

In some embodiments, the portable monitoring unit 400 may be mounted using different attachment mechanisms depending on the trailer configuration. For example, the unit may include insulated mounting brackets compatible with refrigerated trailer wall systems. For other containers, the unit may utilize specialized brackets configured to engage with the container's corner posts or wall. In trailers without track systems, temporary mounting plates or high-strength magnetic mounts may be used to secure the unit. The mounting system may be adapted for different trailer types through modular bracket structures. Quick-release mechanisms also enable quick unit deployment. Other mounting options may include vibration isolation for rough transport conditions or reinforced security features for high-risk cargo.

The mounting location of the portable monitoring unit 400 may be adjusted based on specific monitoring requirements. While mounting near the rear door provides coverage for access monitoring, the unit may alternatively be mounted midway along the trailer walls, near the ceiling, or in other strategic locations to accommodate different cargo configurations or security needs. The unit's self-contained configuration and mounting options enable it to be easily repositioned or transferred between trailers as needed.

The portable monitoring unit 400 may also integrate multiple monitoring and communication components within the unit. The monitoring unit 400 may comprise a motion detection sensor that monitors the cargo area for unauthorized activity, an integrated camera system that captures images and/or video when triggered. The unit may include location tracking capabilities through a GPS module, enabling real-time position monitoring of the cargo trailer.

The unit 400 may also include two-way audio communication through an integrated speaker and microphone system, enabling remote monitoring personnel to interact with individuals inside the trailer near the unit when necessary.

The monitoring unit 400 may establish communication with a remote monitoring system through wireless transmission 500. The remote monitoring system may be staffed by remote agents. When the portable monitoring unit 400 detects activity, it transmits alerts and data through the wireless transmission 500 to the remote monitoring system. Remote agents may then assess the situation through the transmitted images, video feeds, and location data, enabling immediate response to potential security threats.

This wireless capability enables the unit to transmit various types of data, including images, video, audio, location information, and alert notifications. The wireless communication may utilize cellular networks, with the ability to automatically switch between carriers to maintain optimal connectivity during transit.

Power for the portable monitoring unit 400 may be provided by an internal battery system, enabling extended operation without external power sources. The unit employs power management features, primarily operating in a low-power standby mode and activating full monitoring capabilities when triggered by detected activity. This power management approach extends battery life while maintaining continuous security coverage.

The specific configuration and operation of these various components, including internal components, power management features, and interaction capabilities, will be described in greater detail with reference to subsequent figures.

As shown, the system provides comprehensive security monitoring without requiring involvement of the vehicle operator 300. This operator-independent architecture is particularly valuable given industry statistics indicating that a significant percentage of cargo theft involves internal personnel. By maintaining a separate, self-contained security system that operates independently of vehicle systems and personnel, the system provides an additional layer of security oversight. The portable monitoring unit 400 can be installed or removed from the cargo trailer 102 as needed, enabling flexible deployment across a fleet of trailers. This portability, combined with the unit's self-contained power supply and wireless communication capabilities, allows transportation companies to efficiently manage security monitoring across multiple cargo trailers. When cargo requires heightened security, a monitoring unit can be quickly deployed to any trailer in the fleet without requiring specialized installation or vehicle modifications. The monitoring unit may be particularly useful in various transportation scenarios including high-value cargo transport, overnight parking situations, drop trailer operations where trailers are left unattended.

Having described the overall security monitoring system deployed in a transportation environment, a more detailed description of the portable monitoring unit and its components will now be provided. The portable monitoring unit integrates various sensors, communication systems, and security features that work together to provide comprehensive cargo monitoring capabilities.

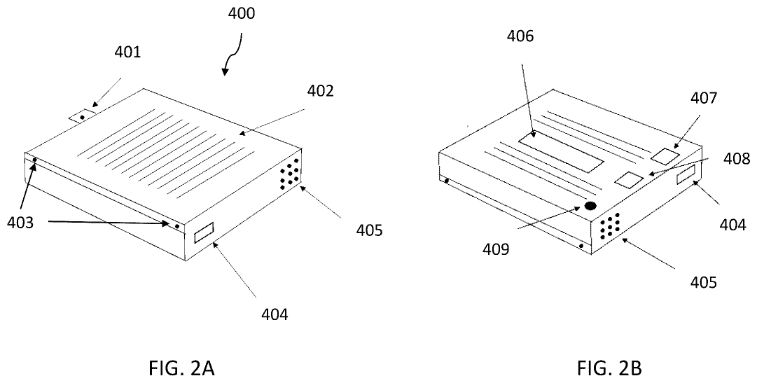

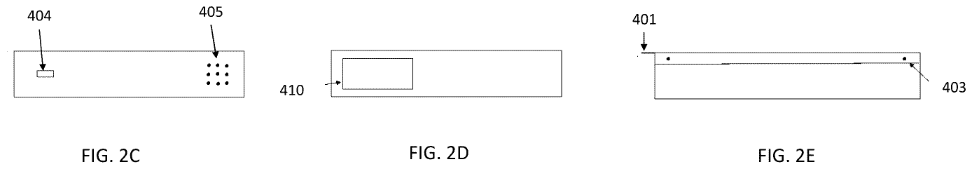

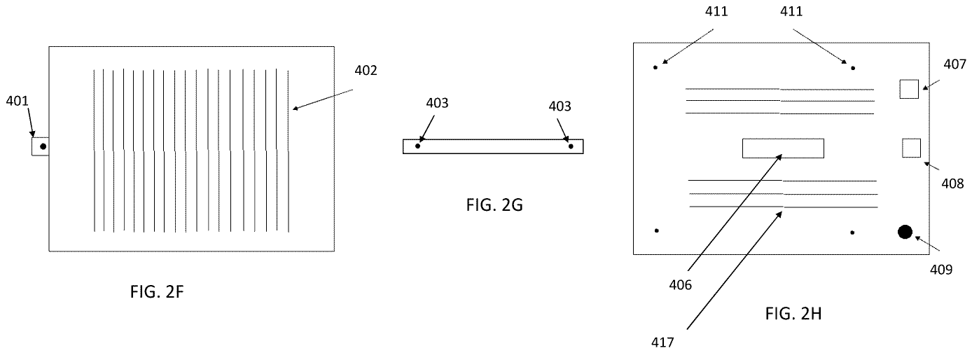

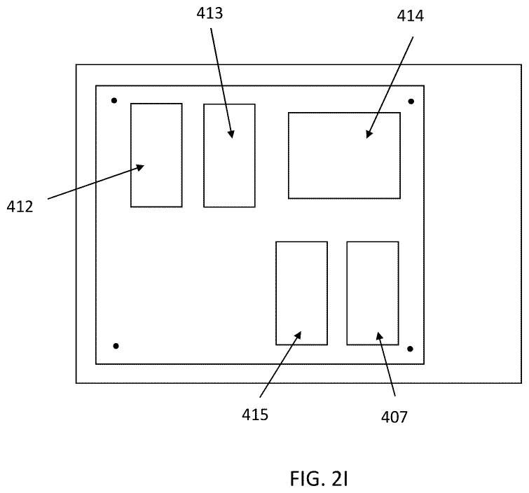

Referring to FIG. 2A, a perspective front view of the portable monitoring unit 400 is illustrated. The monitoring unit 400 comprises a housing configured to protect internal electronic components while enabling performance of monitoring and communication systems.

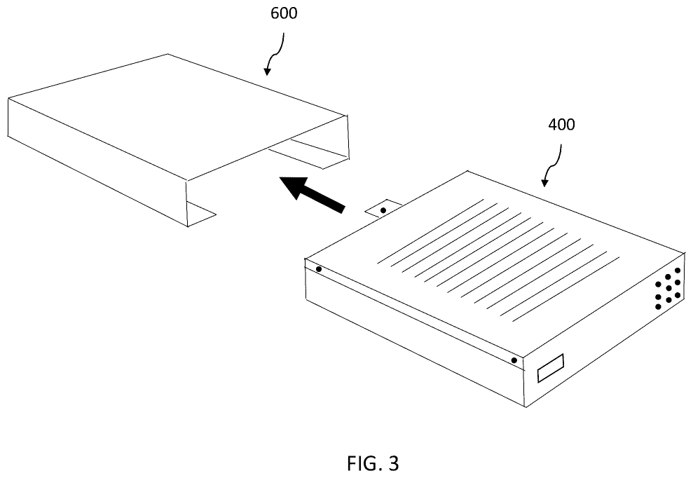

In an embodiment, the monitoring unit 400 also includes a security feature for anti-tampering. A tab 401 incorporating a hole that accepts a padlock extends from the housing and is configured to interface with a mounting bracket. When mounted to its corresponding bracket (detailed in FIG. 3), this locking mechanism prevents unauthorized removal or tampering with the unit. The locking system is positioned to be accessible for authorized installation and removal while being protected from tampering attempts when installed.

The monitoring unit 400 may also include mounting features that slide onto e-track structures of the trailer. Cover plate 420 works as part of the mounting system to secure the monitoring unit 400 to the e-track. The cover plate 420 comprises a tab that extends from the monitoring unit 400. When the monitoring unit 400 slides into position on the e-track, the cover plate 420 extends from the monitoring unit 400 to overlay and engage with the e-track structure. The cover plate 420 includes an extended portion that, when engaged, secures the monitoring unit 400 to the e-track structure by preventing the unit from sliding back out. The configuration of the cover plate 420 enables the monitoring unit 400 to be mounted by sliding the unit into position and removed when the cover plate 420 is disengaged.

The monitoring unit 400 may also be mounted at various heights along the e-track channel by sliding it into position at the desired height. This mounting method requires no permanent modifications to the trailer structure and maintains the original functionality of the e-track system for other uses.

In some embodiments, multiple holes 403 may be strategically positioned around the housing perimeter to accommodate set screws that further secure the unit to its mounting bracket. Once installed, these set screws not only prevent movement during transit but also provide an additional layer of security by making the unit's mounting hardware inaccessible when locked. This enables the unit to remain firmly fixed to the trailer's e-track system and functioning even under rough road conditions or tampering attempts.

The housing of the monitoring unit may also include ventilation slots 402 that may serve multiple functions. One such function is thermal management of the internal components, particularly during active monitoring operations when power consumption and heat generation increase. The slots are arranged in a pattern that promotes cooling while maintaining structural integrity of the housing and preventing water ingress or dust penetration. In high-temperature environments, this cooling system works in conjunction with internal thermal management features such as internal fans to maintain stable operating temperatures. For refrigerated trailer or in colder-temperature environments, the ventilation system may include condensation management features and temperature-resistant materials rated for sub-zero environments.

The monitoring unit 400 also includes a GPS device 404 integrated into the housing's front face. The GPS device 404 provides continuous position data to remote monitoring personnel. When motion is detected within the trailer, the system automatically captures and transmits current GPS coordinates along with monitoring data, enabling rapid response to potential security events. The GPS device 404 may incorporate multi-band reception capabilities to maintain reliable positioning even in challenging environments such as urban locations or covered loading areas.

The monitoring unit 400 may also include a circular cutout 405 configured to receive a speaker system or speaker components. The speaker system may be protected by an impact-resistant grille and enables remote monitoring personnel to establish two-way communication when activity is detected. The speaker's output provides clear audio even with varying cargo configurations. The system detects and notifies monitoring personnel of any activity within the trailer that exceeds a motion sensor sensitivity threshold, whether the activity authorized or unauthorized. When activity is detected, monitoring personnel can use live-voice communication through the speaker system to interact with individuals within the trailer. In the case of unauthorized activity, the system can activate a siren through the speaker. The speaker system may also serve as an audible alert mechanism, capable of producing distinct tones to indicate different types of detected events or system status conditions. Referring to FIG. 2B, a perspective back view of the portable monitoring unit 400 illustrates additional monitoring and communication components. The rear housing configuration accommodates sensors and interfaces that work with the front components to provide comprehensive monitoring capabilities.

In an embodiment, the monitoring unit 400 incorporates a passive infrared (PIR) sensor 407 for motion detection, though any motion detection sensor may be utilized. The PIR sensor 407 continuously monitors the cargo area of human presence. When the unit operates in its standby mode, the PIR sensor 407 functions as the trigger for system activation, detecting motion while consuming minimal power. The sensor's detection field may be calibrated to cover the trailer's interior space while minimizing false triggers from shifting cargo or environmental factors. In operation, when the PIR sensor 407 detects motion, such as the opening of a door, it signals the control system to transition from standby to active monitoring mode. In an embodiment, the sensitivity of the motion sensor can be adjusted such that it only triggers the control system to transition from standby to active monitoring mode when a certain level of motion is detected.

In an embodiment, an IP/IR camera 408 may be positioned adjacent to the PIR sensor 407, providing visual monitoring capabilities in both daylight and complete darkness. The camera 408 incorporates both standard imaging and infrared capabilities, automatically switching between modes based on ambient light conditions. When triggered by the PIR sensor 407, the camera 408 captures high-resolution images and/or video of the cargo area. The camera's field of view may be optimized for trailer interiors, with a wide-angle lens providing coverage from floor to ceiling. The infrared mode may utilize multiple IR LEDs to illuminate the cargo area without visible light, enabling monitoring during nighttime operations.

The monitoring unit may also include a microphone 409 positioned at a rear corner or other suitable location of the housing to enable audio monitoring and two-way communication capabilities. Working in conjunction with the front-mounted speaker 405, the microphone 409 allows remote monitoring personnel to both listen and respond to activity within the trailer. In some embodiments, the audio system may incorporate noise cancellation and filtering algorithms to maintain clear communication despite road noise and environmental sounds. The microphone 409 may also be activated automatically upon motion detection, to start recording audio data along with camera imagery.

The bottom housing may also include a strobe light 406 configured to activate during triggered security events. When unauthorized activity is detected and verified through the monitoring unit, the strobe light 406 provides a high-intensity visual deterrent throughout the trailer interior. The strobe may operate at specific frequencies and patterns that may disorient intruders while providing clear visual indication of system activation. When combined with the audio capabilities of speaker 405, the strobe light 406 creates a deterrent response while alerting nearby personnel to unauthorized trailer access.

In some embodiments, the sensor configuration may be adapted for specific monitoring requirements. The PIR sensor 407 may be supplemented with additional motion detection technologies such as ultrasonic or microwave sensors.

In some embodiments, the camera 408 may incorporate different lens options for various trailer sizes, or multiple cameras may be integrated for expanded coverage. The audio system may be enhanced with additional microphones for advanced sound detection and localization capabilities.

In some embodiments, the strobe light 406 may be configured with different flash patterns, colors, or intensities based on specific security protocols. This may include incorporating multiple strobes positioned at different angles for enhanced coverage or utilize LED arrays capable of producing different lighting effects. The strobe lights may also be programmed to produce distinct patterns for different types of detected events, helping security personnel quickly identify the nature of a security breach.

FIGS. 2C-2E illustrate additional views of the portable monitoring unit 400, showing various aspects of the housing and component placement that enable the monitoring functionalities described above.

FIG. 2C illustrates a front view of the monitoring unit 400, where the GPS device 404 and speaker 405 locations can be seen. The GPS device 404 may extend through the housing surface in a low-profile configuration. The GPS device 404 placement may include a ground plane and radiofrequency (RF) shielding to optimize GPS signal reception while minimizing interference from other system components. The surrounding housing material may additionally provide environmental protection while allowing RF transmission. The speaker 405 may comprise a protective grill with a pattern of openings dimensioned to protect the internal speaker components while maintaining acoustic performance. The grille openings may be arranged in an array that provides clear sound transmission. The grille may also include water-shedding features that guide any condensation or moisture away from the speaker element. In some embodiments, the grille may incorporate coatings or materials to enhance water resistance. In some embodiments the speaker grille may utilize different patterns, sizes, or arrangements to optimize acoustic properties for specific trailer environments or audio requirements.

FIG. 2D illustrates a back view of the monitoring unit 400, revealing the access port 410 for the rechargeable battery system. In an embodiment, the access port 410 incorporates a sliding door mechanism that provides access to the rechargeable battery system while maintaining environmental protection when closed. The sliding mechanism may include integrated stops to prevent door removal and may incorporate sealing elements along the sliding surfaces. Inside the access port 410, there may be keyed guides that enable proper battery orientation during installation and prevent incorrect insertion. The battery compartment may also incorporate drainage channels to protect electrical contacts from moisture accumulation. For applications requiring extended operation periods, the access port 410 may be configured to accept higher capacity batteries.

FIG. 2E presents a side view of the monitoring unit 400, illustrating the tab with hole 401 for accepting a padlock or similar locking device, the cover plate 420 extending from the monitoring unit 400, along with mounting holes 403. The tab with hole 401 aligns with corresponding features on a mounting bracket (shown in FIG. 3) to secure the unit within the trailer. The cover plate 420 includes an extended portion that, when engaged, secures the monitoring unit 400 to the e-track structure. The mounting holes 403 accept set screws that prevent unit movement once installed.

In some embodiments, the monitoring unit 400 may measure approximately 14 inches in length, 12 inches in width, and 4 inches in height. The side profile may maintain a 1-inch thickness to minimize protrusion into the cargo space while providing sufficient internal volume for components. The tab with hole 401 may extend approximately 1 inch from the housing body. In some embodiments, the housing dimensions may be modified to accommodate different component configurations or installation requirements. For example, a low-profile version may measure 10 inches by 8 inches with a 3-inch height for applications with space constraints.

Alternatively, an extended capacity version may measure 16 inches by 14 inches with a 5-inch height to accommodate additional batteries or monitoring components. The mounting hole spacing, and tab dimensions may be adjusted to match various trailer mounting systems while maintaining secure installation capabilities.

FIG. 2F illustrates a top view of the monitoring unit 400 showing the ventilation slot configuration 402. The ventilation configuration consists of parallel slotted louvers arranged across the housing surface. The louvers extend across the majority of the top surface length, positioned strategically to enable airflow over internal components while maintaining structural integrity of the housing. The ventilation slots 402 incorporate angled surfaces that promote natural cooling while preventing direct water ingress. The louver configuration may also allow for continuous airflow during operation while protecting internal components from environmental elements. The louver may also incorporate integrated drainage channels along the slot edges to direct any accumulated moisture away from the internal electronics. The ventilation system works in conjunction with additional ventilation slots on the bottom surface to create a complete thermal management system.

FIG. 2G provides an isolated view of the mounting holes 403 that work in conjunction with the backplate mounting holes 411. The mounting holes 403 accept set screws for securing the unit to a corresponding mounting bracket. The backplate mounting holes 411 may be positioned around the housing perimeter to distribute mounting forces evenly across the assembly.

FIG. 2H illustrates a bottom view of the housing, showing additional ventilation slots 417 arranged above and below the strobe light 406. The ventilation slots 417 complete the airflow path initiated by the top slots 402, enabling efficient thermal management throughout the unit. The bottom surface integrates the strobe light 406, PIR sensor 407, IP/IR camera 408, and microphone 409. The strobe light 406 is positioned centrally for maximum illumination coverage within the trailer space. The PIR sensor 407 and camera 408 are arranged to provide overlapping detection fields, while the microphone 409 is placed to optimize audio capture capabilities.

In some embodiments, the ventilation configuration may be modified based on operating environment requirements. The slot patterns may be adjusted for different airflow characteristics or enhanced environmental protection. In some embodiments, the component layouts may be modified to accommodate additional sensors or multiple strobe lights for enhanced coverage in larger trailers. In some embodiments, alternative mounting hole patterns may be implemented to support various installation scenarios while maintaining secure attachment of the unit.

FIG. 2I illustrates the internal component layout of the portable monitoring unit 400. The internal configuration houses the electronic systems that enable monitoring, detection, analysis, and communication capabilities while managing power consumption for extended deployment periods.

A battery 412 forms the basis of the power management system. The battery 412 may be rechargeable, in an embodiment. During standard operation, the battery 412 maintains charge levels through an intelligent charging system that prevents overcharging while optimizing battery life cycles. A relay system 413 manages power distribution from the battery 412 to system components. The relay 413 incorporates solid-state switching to control power states, maintaining the unit in standby mode while monitoring for activation triggers. When motion detection occurs, the relay 413 sequences power activation to camera systems, processing units, and communication modules. Using this standby mode/active mode combination, the battery system provides power distribution throughout the unit while enabling up to 21 days of continuous operation in standby mode. If active mode is triggered, the battery system may enable up to 24 hours of continuous operation in active mode. In some embodiments, the power management system may incorporate ultracapacitor storage for high-current operations. Advanced charging systems may enable rapid battery replacement without system shutdown.

The CPU 414 operates as the system control center, running an operating system configured for security monitoring applications. The processing system may incorporate a modern microprocessor architecture that balance computational capabilities with power efficiency, consuming minimal power in standby mode while providing sufficient processing capacity during full operation. The CPU 414 may be any means configured to execute various programmed operations or instructions stored in a memory device such as a device or circuitry operating in accordance with software or otherwise embodied in hardware or a combination of hardware and software (e.g., a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions. The memory may be configured to store instructions, computer program code, operational codes and instructions, data (such as location/position data), and other data in a non-transitory computer readable medium for use.

Upon activation from standby mode, the CPU 414 manages the image capture sequence. In an embodiment, the camera system initiates continuous image capture at 1-second, 2-second, 3-second, 4-second, or 5-second intervals, or at any other interval known in the art.

The system may be configured to capture images at regular intervals, with timing between captures adjustable from 1 to 20 seconds. In this embodiment, each image undergoes immediate processing through machine learning algorithms that analyze pixel patterns to detect human presence, movement patterns, and/or cargo displacement. The image processing system may incorporate multiple machine learning models trained specifically for trailer environments. These models may analyze lighting variations, shadow patterns, and movement characteristics to differentiate between authorized and unauthorized activities. The analysis may include object recognition capabilities to identify human forms while filtering out cargo movement, animals, bugs, or environmental changes.

Upon activation from standby mode due to the motion trigger, the CPU 414 may alternatively or simultaneously activate video recording capabilities. The video system captures footage at frame rates sufficient for detailed motion analysis within the trailer environment. The system may maintain a continuous video buffer that enables capture of activity both before and after a trigger event occurs. When motion is detected, the system automatically compiles a video clip containing footage from before and after the trigger capturing 5 seconds prior to trigger and 5 seconds after, though these durations may be adjusted up to 30 seconds. A continuous video buffer maintains pre-trigger footage, enabling review of events leading up to motion detection.

During an active alert, the system transmits these compiled video clips to monitoring personnel while simultaneously maintaining a live video feed that agents can access to view current activity within the trailer in real-time. In an embodiment, the system processes video and still images simultaneously-the still images undergo machine learning analysis to detect unauthorized access or cargo tampering, while the continuous video recording provides a complete record of events during active monitoring periods. The video processing may include automatic adjustment of exposure and focus settings based on trailer lighting conditions, while infrared capabilities enable recording in low-light environments. This dual capture system offers both the detailed frame analysis needed for artificial intelligence processing and comprehensive video documentation for security verification and incident investigation. The video recording automatically includes time stamps, GPS coordinates, and system status information overlaid in a non-interfering manner, providing complete context for each recorded event.

Furthermore, an audio interface 415 can also be included, which controls the audio processing systems. The interface incorporates dedicated digital signal processors for real-time audio enhancement, enabling clear two-way communication in high-noise environments. Audio processing may include adaptive noise cancellation algorithms that adjust to varying trailer acoustics and environmental conditions. The audio system maintains continuous monitoring through the microphone. When an event occurs, the audio capture system marks the trigger point and preserves audio context before and after the event. The audio processing may include frequency analysis to detect specific sound patterns associated with door openings, human movement, or cargo displacement.

Data from image analysis, video capture, and audio processing feeds into the machine learning system. The artificial intelligence algorithms compare current data against baseline patterns established during system initialization. This analysis identifies deviations in cargo placement, unexpected motion patterns, or unauthorized presence within the trailer space. The CPU 414 manages wireless communication through an integrated cellular modem. When the system detects activity warranting investigation, it packages image data, video data, location coordinates, and system status information for transmission to remote monitoring personnel. The transmission protocol may include data compression and encryption to enable secure, efficient communication. Remote monitoring personnel receive event data through a dedicated interface system. This interface presents captured images alongside real-time video feeds, enabling immediate assessment of trailer conditions. The remote system maintains two-way control of the monitoring unit, allowing operators to adjust camera settings, modify detection parameters, or initiate direct communication through the audio system.

The operating system coordinates component interactions through operational states. In standby mode, the system may conduct periodic self-diagnostics while monitoring battery conditions and sensors. Active mode engages full system capabilities including continuous image capture, video recording, and data analysis. During alert conditions, the system may increase data capture rates while activating deterrent systems. The strobe may activate in patterns synchronized with video capture to enable clear image recording during deterrent operation.

Audio alerts can be programmed to automatic or manual activation based on threat assessment protocols.

In some embodiments, the system may also incorporate internal sensors for environmental monitoring for temperature and humidity. These sensors protect internal components while providing additional data points for event analysis. Temperature monitoring enables automatic thermal management through the ventilation system while preventing condensation formation on optical components.

In some embodiments, communication capabilities may be expanded through satellite connectivity options. These systems enable operation in areas without cellular coverage while providing communication paths. In some embodiments, communication systems may incorporate mesh networking capabilities enabling multiple units to operate properly. These networks may provide extended coverage for large facilities while enabling unit-to-unit communication for coordinated monitoring. In some embodiments, there may include local wireless access points for maintenance operations. The audio processing system may be enhanced through additional microphone arrays enabling better sound detection. These systems can localize sound sources within the trailer space while providing improved noise cancellation capabilities. Advanced audio processing may include voice recognition capabilities to identify authorized personnel or detect specific acoustic signatures.

In some embodiments, the machine learning system may incorporate specialized models for different cargo types or trailer configurations. These models may optimize detection capabilities for specific transportation scenarios while reducing false alerts.

In some embodiments, visual monitoring capabilities may be expanded through infrared imaging systems or photoelectric sensors. These systems provide enhanced detection capabilities in complete darkness while enabling temperature monitoring of cargo areas.

Specialized lens systems may incorporate zoom capabilities or adjustable fields of view for different trailer configurations.

In some embodiments, strobe configurations may also be included with programmable activation patterns. Color-changing LED systems enable different warning levels while maintaining power efficiency. In some embodiments, the strobe may incorporate focused beam patterns for targeted illumination of specific trailer areas.

FIG. 3 illustrates the mounting system for the portable monitoring unit 400, showing the relationship between the monitoring unit and a corresponding mounting bracket 600. The mounting system enables secure installation within cargo trailers while maintaining accessibility for authorized removal or repositioning.

In an embodiment, the bracket 600 incorporates a slot configured to receive the tab with hole 401 from the monitoring unit 400. The mounting process involves aligning the unit with the bracket's guide surfaces and sliding the unit horizontally until the tab engages with the slot. When fully engaged, the holes in the tab and bracket align to accept a padlock, preventing unauthorized removal of the unit.

In an embodiment, the bracket 600 includes mounting features compatible with industry-standard track systems found in cargo trailers. The bracket's rear surface incorporates hooks or flanges that engage with the track slots, allowing installation at any height along the trailer walls. This compatibility with existing trailer infrastructure eliminates requirements for additional mounting hardware or trailer modifications. Installation of the monitoring unit 400 follows a straightforward sequence. The bracket 600 attaches to the track through a hook-and-lock motion. The monitoring unit 400 then slides horizontally into the mounted bracket, guided by alignment features that enable proper orientation. Once the unit reaches its fully seated position, the tab and bracket holes align for padlock insertion.

In an embodiment, the mounting system includes set screw positions that engage when the unit is fully seated. These set screws prevent movement or vibration during transit while providing additional security against tampering attempts. The bracket 600 accommodates the ventilation requirements of the monitoring unit. Spacing between the bracket and trailer wall allows airflow through the unit's ventilation slots, maintaining proper thermal management during operation. The bracket structure also protects internal connections and interface ports while maintaining their accessibility.

For trailer configurations without track systems, alternative bracket configurations may be implemented to enable mounting to different structural elements. These variations maintain the same sliding engagement mechanism while adapting the rear bracket features for various mounting scenarios. The bracket system may incorporate additional mounting points for permanent installation requirements.

The monitoring unit's removal process reverses the installation sequence. After padlock removal and set screw disengagement, the unit slides horizontally out of the bracket.

This enables quick unit transfers between trailers while maintaining security when locked in position.

In some embodiments, the bracket dimensions accommodate various standard sizes known in the art, including monitoring units measuring 14 inches in length, 12 inches in width, and 4 inches in height. In some embodiments, the mounting holes or attachment points of the bracket may be spaced 16 inches apart measured from their centers, aligning with standard e-track spacing in cargo trailers. The bracket's engagement slot accepts the unit's 1-inch width tab while providing sufficient guidance surfaces for smooth installation. Alternative bracket sizes may accommodate different unit dimensions for specialized applications.

The mounting system may incorporate various security features beyond the basic padlock configuration. These may include electronic locks, tamper-evident seals, or integrated alarm contacts that trigger alerts if removal is attempted. In some embodiments there may be brackets with additional locking points for high-security applications. In some embodiments, the mounting system may incorporate a quick disconnect mechanism that enables rapid attachment and detachment of the monitoring unit to the e-track structure when properly accessed. In this embodiment, the cover plate 420 overlays the quick disconnect mechanism, preventing access to the release mechanism. When secured in place, cover plate 420 makes removal of both the bracket and monitoring unit inaccessible without first unlocking and removing the cover plate 420. This configuration prevents unauthorized removal while maintaining efficient installation and transfer capabilities for authorized personnel.

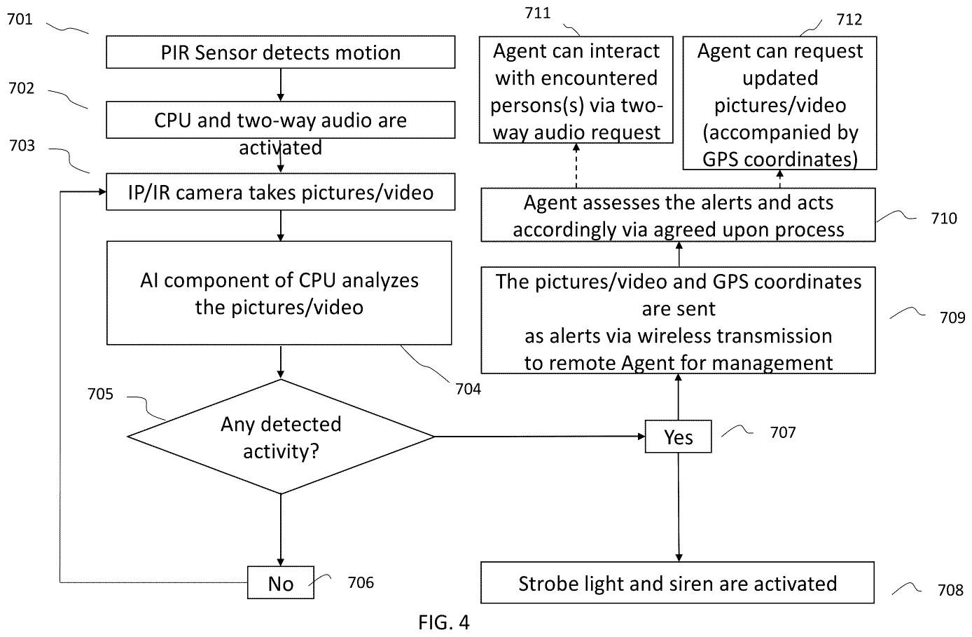

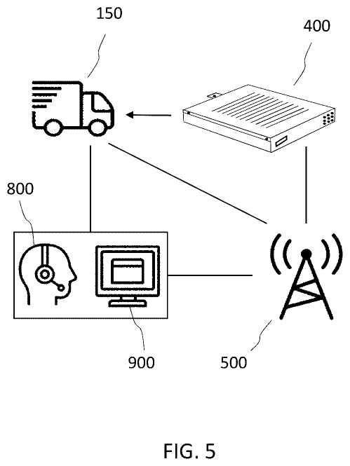

FIG. 4 illustrates a flowchart depicting the operational sequence of the portable monitoring unit. The flowchart represents various operations performed by the system components in accordance with embodiments of the present disclosure.

The sequence begins at operation 701 where the PIR sensor detects motion within the monitored area of the cargo trailer. The motion detection serves as a trigger to transition the system from standby mode to active monitoring state. In an embodiment, following motion detection, at operation 702, the CPU and, optionally, a two-way (duplex) audio system activates. This activation sequence includes power-up routines for the processing systems and initialization of audio monitoring capabilities. The audio system begins buffering sound from the monitored area while preparing two-way communication channels.

At operation 703, the IP/IR camera initiates capture of pictures and video of the trailer interior. The camera system employs both standard and infrared imaging capabilities, automatically selecting appropriate modes based on lighting conditions. The system captures high-resolution still images while simultaneously recording video to provide comprehensive documentation of detected events.

Operation 704 involves CPU analysis of the captured pictures and video, comparing them with previously obtained baseline images. The analysis utilizes machine learning algorithms to evaluate changes in the monitored space, examining factors such as cargo positions, human presence, and door status.

The system enters a decision point at operation 705, determining whether differences exist between the captured images and video. This comparison examines multiple image parameters to identify potential security events while filtering normal environmental variations.

When no differences are detected, the process follows path 706, continuing monitoring operations while maintaining image capture for ongoing comparison. The system retains recent images to maintain current baseline references for future comparisons.

If differences are detected, the process proceeds through path 707, triggering a series of automated responses and alerts. The system marks this as a verified security event requiring further action and monitoring. Operation 708 activates the strobe light and/or siren components of the monitoring unit. These deterrent measures serve both to indicate system activation and to discourage unauthorized activity within the monitored space.

At operation 709, the system transmits the captured pictures and video and GPS coordinates via wireless transmission using cellular/satellite connectivity to remote monitoring personnel. This data package may include time stamps, location data, and system status information to provide context for the detected event.

Operation 710 represents the assessment phase where monitoring agents evaluate the transmitted alerts according to established protocols. The agents review the received imagery and location data to determine appropriate response measures based on client-specific procedures.

Through operation 711, agents can establish two-way audio communication with any persons detected within the monitored area. This capability enables direct interaction through the monitoring unit's speaker and microphone systems, allowing for identification verification or challenge protocols.

Operation 712 permits agents to request updated pictures and video with accompanying GPS coordinates. This function enables continuous monitoring of the situation as it develops, providing real-time visual verification of conditions within the trailer.

The system maintains this monitoring and communication state while agents assess and respond to the situation. During this period, the video recording system continues to capture footage, maintaining a complete record of events. Throughout these operations, the monitoring unit transmits regular status updates including battery levels, connection strength, and system health indicators to enable reliable operation.

The sequence includes automated return paths to resume standard monitoring once alert conditions are resolved. This transition maintains system readiness while conserving power through selective component activation. When the system detects door closure or no motion, it initiates a monitoring period to verify the end of activity before transitioning back to standby mode. GPS tracking continues throughout all operational states, enabling location verification even during standby periods. This location monitoring aids in tracking trailer movements and verifying delivery locations. The sequence concludes when monitoring agents confirm resolution of the alert condition, allowing the system to return to its power-conserving standby mode while maintaining motion detection readiness.

This operational flow enables the monitoring unit to provide comprehensive security coverage while managing power consumption through selective activation of components based on detected events and monitoring requirements.

FIG. 5 illustrates a schematic overview of the communication architecture between the portable monitoring unit 400, transportation vehicle 150, remote agent 800, and remote monitoring system 900.

The remote monitoring system 900 functions as a central command center where transmitted alerts, images, video feeds, and location data are received and processed. The system incorporates interface screens displaying real-time monitoring data, enabling agents to assess multiple alerts simultaneously.

Remote agents 800 interact with the monitoring system 900 through workstations configured for alert management and response coordination. The monitoring system 900 processes incoming transmissions through multiple stages, first verifying data and GPS coordinates, then routing alerts to available agents based on predefined protocols and geographic zones. This routing system enables efficient distribution of monitoring responsibilities across the agent workforce.

Communication between the portable monitoring unit 400 and the remote monitoring system 900 occurs through a wireless communication infrastructure 500, with the system automatically selecting optimal carriers to maintain consistent connectivity. The monitoring system 900 includes communication paths to prevent service interruptions. The wireless communication infrastructure enables data transmission between the portable monitoring unit 400 and remote monitoring system 900. This wireless infrastructure maybe cellular or satellite connectivity and supports transmission of video feeds, still images, GPS coordinates, and two-way audio communications, while allowing the system to automatically switch between available carriers and signal bands to maintain optimal connection strength.

Remote agents 800 access response tools through the monitoring system 900, including two-way audio controls, video feed requests, and alert acknowledgment functions.

These tools enable agents to manage security events while maintaining complete documentation of all actions taken.

The monitoring system 900 maintains continuous recording of all transmissions, agent responses, and system events. This recorded data provides a trail of security events and response measures, while enabling analysis of response effectiveness and procedure refinement. Integration between remote agents 800 and the monitoring system 900 allows for coordinated responses to multiple simultaneous alerts. Agents can transfer alert handling responsibilities through the system while maintaining continuity of response measures.

The remote monitoring system 900 may incorporate automated dispatch protocols, enabling agents to quickly contact law enforcement or other emergency services when necessary. The system may automatically include relevant location data and site information with these dispatch requests.

### Conclusion

Many modifications and other embodiments of the disclosures set forth herein will come to mind to one skilled in the art to which these present disclosures pertain having the benefit of the teachings presented in the foregoing descriptions and the associated drawings.

Therefore, it is to be understood that the embodiments of the present disclosure are not to be limited to the specific embodiments disclosed and that modifications and other embodiments are intended to be included within the scope of the present disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the present disclosure. In this regard, for example, different combinations of elements and/or functions than those explicitly described above are also contemplated within the scope of the present disclosure. Although specific terms are employed herein, they are used in a generic and descriptive sense only and not for purposes of limitation.

1. A portable security monitoring system for a cargo trailer, comprising:
a housing configured to be mounted within an interior of the cargo trailer;
a monitoring unit configured to be housed by the housing and comprising a motion detection sensor, a camera, an alarm device, a battery configured to power the monitoring unit independently of any vehicle electrical system, a GPS device, and a wireless communication module configured to transmit video data and location data to a remote monitoring system; and
a controller operatively coupled to the monitoring unit and configured to:
cause the monitoring unit to operate in a low-power standby mode,
cause the monitoring unit to transition to an active mode upon motion detection sensed by the motion detection sensor, wherein, when the monitoring unit transitions into active mode, it is configured to:
cause the camera to initiate time-stamped video recording to capture video of the interior of the cargo trailer, cause the GPS device to capture location data for the monitoring unit and transmit the captured time-stamped video and the location data to a remote monitoring system via the wireless communication module, and activate the alarm device.

2. (canceled)

3. The portable security monitoring system of claim 1, wherein the system does not require interaction from a vehicle operator.

4. The portable security monitoring system of claim 6, wherein the speaker output is live or prerecorded.

5. The portable security monitoring system of claim 1, further comprising a two-way communication interface comprising:
a microphone for receiving audio from within the cargo trailer, and
a speaker for outputting audio from the remote monitoring system.

6. The portable security monitoring system of claim 1, wherein the alarm device comprises:
a visual indicator capable of displaying varying illumination patterns, and
a speaker configured to emit an audible alert.

7. The portable security monitoring system of claim 1, wherein the camera is further configured to capture images of the cargo trailer interior in the active mode, and wherein the monitoring unit is configured to transmit the captured image to the remote monitoring system along with the captured video.

8. The portable security monitoring system of claim 1, wherein the battery comprises a rechargeable battery configured to power the monitoring unit for a first predetermined period in the standby mode and a second predetermined period of time in the active mode.

9. The portable security monitoring system of claim 1 additionally comprising a mounting feature for securing the housing to an interior track structure of the cargo trailer, wherein the mounting feature comprises a bracket configured to engage with existing track structures within the cargo trailer.

10. The portable security monitoring system of claim 5, wherein the microphone of the monitoring unit within the cargo trailer is further configured to:
record audio within the cargo trailer during the trigger event, and
transmit the recorded audio to the remote monitoring system.

11. The portable security monitoring system of claim 1, wherein the video recording is maintained for a predetermined duration following the motion detection of unauthorized activity.

12. The portable security monitoring system of claim 1, wherein the motion detection sensor comprises at least one of: a passive infrared sensor, an optical sensor, a microwave sensor, or an ultrasonic sensor.

13. The portable security monitoring system of claim 1, wherein the camera comprises an infrared camera configured to capture video in low-light conditions.

14. A portable security monitoring system for a cargo trailer, comprising:
a housing configured to be mounted within an interior of the cargo trailer; a monitoring unit configured to be housed by the housing and comprising a motion detection sensor, a camera, an alarm device, a battery configured to power the monitoring unit independently of any vehicle electrical system, a GPS device, and a wireless communication module configured to transmit image data and location data to a remote monitoring system; and
a controller operatively coupled to the monitoring unit and configured to:
cause the monitoring unit to operate in a low-power standby mode,
cause the monitoring unit to transition to an active mode upon motion detection sensed by the motion detection sensor, wherein, when the monitoring unit transitions into active mode, it is configured to:
cause the camera to capture at least one time-stamped image of the interior of the cargo trailer, cause the GPS device to capture location data for the monitoring unit and transmit the at least one captured image, a time stamp of the trigger event, and the location data to a remote monitoring system via the wireless communication module, and activate the alarm device.

15. The security monitoring device of claim 14, wherein the camera is further configured to transmit a real-time video feed of the cargo trailer interior in the active mode, wherein the controller is configured to transmit the real-time video feed to the remote monitoring system.

16. The security monitoring device of claim 14, further comprising a two-way communication interface comprising:
a microphone for receiving audio from within the cargo trailer, and
a speaker for outputting audio from the remote monitoring system.

17. The security monitoring device of claim 14, wherein the camera is further configured to capture video of the cargo trailer interior in the active mode, wherein the controller is configured to transmit the captured video to the remote monitoring system.

18. The security monitoring device of claim 14, wherein the microphone of the monitoring unit is further configured to:
record audio within the cargo trailer during the trigger event, and
transmit the recorded audio to the remote monitoring system.

19. The security monitoring device of claim 14, wherein the device does not require interaction from a vehicle operator.

20. A remote monitoring device for a cargo trailer, comprising:
a housing configured to be mounted within an interior of the cargo trailer; a monitoring unit configured to be housed by the housing and comprising:
a motion detection sensor, a camera, an alarm device, a battery configured to power the monitoring unit independently of any vehicle electrical system, a GPS device, and a wireless communication module configured to transmit image data, video data and location data to a remote monitoring system;
a controller operatively coupled to the monitoring unit and configured to:
cause the monitoring unit to operate in a low-power standby mode,
cause the monitoring unit to transition to an active mode upon motion detection sensed by the motion detection sensor, wherein, when the monitoring unit transitions into active mode, it is configured to, initiate video recording and capture at least one time-stamped image via the camera of the detected motion, cause the GPS device to capture location data for the monitoring unit and transmit the captured video, the at least one captured image, a time stamp of the trigger event, and the location data to a remote monitoring system via the wireless communication module, and activate the alarm device.
